(19) United States
(12) Patent Application Publication
(10) Pub. No.: US 2025/0053580 A1
(43) Pub. Date: Feb. 13, 2025

(54) DISPLAY OF MOST ACTIONABLE INFORMATION

(71) Applicant: ZeroAvia Ltd, Cirencester (GB)

(72) Inventors: Stephen Lawes, Cirencester (GB); Prasanna Kumar, Cirencester (GB); Kevin-Patxi Le Bras, Cirencester (GB); Sandeep Kaley, Cirencester (GB)

(21) Appl. No.: 18/796,022

(22) Filed: Aug. 6, 2024

(30) Foreign Application Priority Data
Aug. 7, 2023 (GB) 2312091.8

(51) Int. Cl. G06F 16/28; B64D 45/00

(52) U.S. Cl. CPC G06F 16/287; B64D 45/00; B64D 2045/0085

(57) ABSTRACT

Disclosed is a method for displaying actionable information on an electronic vehicle display panel which includes: receiving data from a plurality of sensors. The data received from each of the plurality of sensors is analyzed to determine a data category for the data from each sensor, wherein each data category corresponds to an information priority level. The data from each of the plurality of sensors is displayed according to the determined data category, wherein data within a data category corresponding to a high information priority level is displayed more prominently relative to other data, and wherein data within a data category corresponding to a low information priority level is displayed less prominently relative to other data; and displaying at least a portion of the data as at least one from the set of: a fuel cell voltage difference, a hydrogen flow rate, a temperature discrepancy, and a rate of temperature change.

### CROSS REFERENCE TO RELATED APPLICATIONS

This application claims priority to United Kingdom Application No. 2312091.8, filed Aug. 7, 2023, the contents of which are incorporated herein in their entirety.

### TECHNICAL FIELD

The present disclosure relates to information display for vehicles. The disclosure has particular utility for hydrogen fuel cell aircraft and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

Aircraft flight crew are responsible for maintaining their aircraft in a safe operational state. During flight, a crew is subject to numerous sources of information indicating the operational status of the aircraft. These sources of information may primarily include sensors located throughout the aircraft and conveying data related to the aircraft systems, the flight, and/or ambient conditions.

When the data from these sensors is presented all at once, flight crews may gloss over, miss, or fail to process important information. When the data from these sensors is presented piecemeal, flight crews may not have available all the information necessary to make decisions in the event of critical events. In either scenario, flight crews are required to make in situ determinations as to what information attention should be paid during a flight, rather than focusing on the information itself. Thus, there is a need for systems and methods that prioritize in-flight information presented to flight crews.

Embodiments of the present disclosure provide a method for displaying actionable information on an electronic vehicle display panel, such as an aircraft display panel. In this regard, one embodiment of such a method, among others, can be broadly summarized by the following steps: receiving data from a plurality of aircraft sensors; analyzing the data received from each of the plurality of sensors to determine a data category for the data from each sensor, wherein each data category corresponds to an information priority level; displaying the data from each of the plurality of sensors according to the determined data category, wherein data within a data category corresponding to a high information priority level is displayed more prominently relative to other data, and wherein data within a data category corresponding to a low information priority level is displayed less prominently relative to other data; and displaying at least a portion of the data as at least one from the set of: a fuel cell voltage difference, a hydrogen flow rate, a temperature discrepancy, and a rate of temperature change.

In one aspect, the method further comprises the steps of: determining if the data received from each of the plurality of sensors is human-actionable; and for data that is human-actionable, displaying that data in a native state, and for data that is not human-actionable, processing the non-human-actionable data to a human-actionable parameter and displaying the processed data.

In another aspect, the information priority level is one selected from the set of: data that is discarded, data to be reviewed, data displayed on demand, data displayed on low conspicuousness, data displayed in the primary display, highlighted data, signals to master caution, signals to master alarm, audio alerts, and control overrides.

In another aspect, the method further comprises the step of displaying a user-selectable toggle wherein, depending on the data received from the plurality of vehicle sensors, operation of the vehicle is switchable between a normal operation and a limp home operation. In a particular aspect, the vehicle is an aircraft, and the display further includes at least one from the set of: an indicator of a failed aircraft sensor, an indicator of the selected operating mode, and a manual override against limp home operation.

In another aspect, the vehicle is an aircraft, and the data category is at least partially determined by whether a value of the data from the aircraft sensor falls within a nominal, caution, or warning range.

In another aspect, the vehicle is an aircraft, and the method further comprises the steps of: grouping data from a plurality of aircraft sensors together to create at least one data bin; determining a data category of the at least one data bin; and displaying an operating status of the at least one data bin. In a particular aspect, and as applied specifically to hydrogen fuel cell powered aircraft, the at least one data bin is at least one of: motor fuel cell, motor battery, inverter, fuel cell voltage, battery management system, pump, contactor, hydrogen management system, thrust, or power system controller.

In another aspect, the vehicle is an aircraft, and at least one aircraft sensor data is displayed as a rate of change of the data. In a particular aspect, a parameter displayed as a rate of change of the data is at least one of: high temperature coolant loop inlet, high temperature coolant loop outlet, or cathode heat exchanger parameters.

The present disclosure can also be viewed as providing a system for displaying actionable information on a vehicle such as an aircraft. Briefly described, in architecture, one embodiment of the system, among others, can be implemented as follows. A system for displaying actionable information on a vehicle includes an electronic display panel. A processor is in communication with the electronic display panel. The processor has computer-readable memory and a power supply. A plurality of sensors is in electrical communication with the processor. The processor is configured to: receive data from the plurality of sensors; analyze the data received from each of the plurality of sensors to determine a data category for the data from each sensor, wherein each data category corresponds to an information priority level; control the electronic display panel to display the data from each of the plurality of sensors according to the determined data category, wherein data within a data category corresponding to a high information priority level is displayed more prominently relative to other data, and wherein data within a data category corresponding to a low information priority level is displayed less prominently relative to other data; and control the electronic display panel to display at least a portion of the data as at least one from the set of: a fuel cell voltage difference, a hydrogen flow rate, a temperature discrepancy, and a rate of temperature change.

In one aspect, the processor is further configured to: determine if the data received from each of the plurality of sensors is human-actionable; and for data that is human-actionable, display that data in a native state, and for data that is not human-actionable, process the non-human-actionable data to a human-actionable parameter and display the processed data.

In another aspect, the information priority level is one selected from the set of: data that is discarded, data to be reviewed, data displayed on demand, data displayed on low conspicuousness, data displayed in the primary display, highlighted data, signals to master caution, signals to master alarm, audio alerts, and control overrides.

In another aspect, the processor is further configured to display a user-selectable toggle wherein, depending on the data received from the plurality of sensors, operation of the vehicle is switchable between a normal operation and a limp home operation. In a particular aspect, the display further includes at least one from the set of: an indicator of a failed sensor, an indicator of the selected operating mode, and a manual override against limp home operation.

In another aspect, the data category is at least partially determined by whether a value of the data from the aircraft sensor falls within a nominal, caution, or warning range.

In another aspect, the processor is further configured to: group data from a plurality of aircraft sensors together to create at least one data bin; determine a data category of the at least one data bin; and display an operating status of the at least one data bin. In a particular aspect, the at least one data bin is at least one of: motor fuel cell, motor battery, inverter, fuel cell voltage, battery management system, pump, contactor, hydrogen management system, thrust, or power system controller.

In another aspect, at least one aircraft sensor data is displayed as a rate of change of the native data. In a particular aspect, a parameter displayed as a rate of change of the data is at least one of: high temperature coolant loop inlet, high temperature coolant loop outlet, or cathode heat exchanger parameters.

According to aspect A of the present invention there is provided a method for displaying actionable information on a vehicle display panel, comprising the following steps: receiving data from a plurality of aircraft sensors; analyzing the data received from each of the plurality of sensors to determine a data category for the data from each sensor, wherein each data category corresponds to an information priority level; displaying the data from each of the plurality of sensors according to the determined data category, wherein data within a data category corresponding to a high information priority level is displayed more prominently relative to other data, and wherein data within a data category corresponding to a low information priority level is displayed less prominently relative to other data; and displaying at least a portion of the data as at least one from the set of: a fuel cell voltage difference, a hydrogen flow rate, a temperature discrepancy, and a rate of temperature change.

Preferably the method further comprises the steps of: determining if the data received from each of the plurality of sensors is human-actionable; and for data that is human-actionable, displaying that data in a native state, and for data that is not human-actionable, processing the non-human-actionable data to a human-actionable parameter and displaying the processed data.

Preferably the information priority level is one selected from the set of: data that is discarded, data to be reviewed, data displayed on demand, data displayed on low conspicuousness, data displayed in the primary display, highlighted data, signals to master caution, signals to master alarm, audio alerts, and control overrides.

Preferably the method further comprises the step of displaying a user-selectable toggle wherein, depending on the data received from the plurality of aircraft sensors, operation of the vehicle is switchable between a normal operation and a limp home operation.

Preferably the vehicle is an aircraft, and wherein the display further includes at least one from the set of: an indicator of a failed aircraft sensor, an indicator of the selected operating mode, and a manual override against limp home operation.

Preferably the vehicle is an aircraft, and wherein the data category is at least partially determined by whether a value of the data from the aircraft sensor falls within a nominal, caution, or warning range.

Preferably the vehicle is an aircraft, and further comprising the steps of: grouping data from a plurality of aircraft sensors together to create at least one data bin; determining a data category of the at least one data bin; and displaying an operating status of the at least one data bin.

Preferably the at least one data bin is at least one of: motor fuel cell, motor battery, inverter, fuel cell voltage, battery management system, pump, contactor, hydrogen management system, thrust, or power system controller.

Preferably the vehicle is an aircraft, and wherein at least one aircraft sensor data is displayed as a rate of change of the data.

Preferably a parameter displayed as a rate of change of the data is at least one of: high temperature coolant loop inlet, high temperature coolant loop outlet, or cathode heat exchanger parameters.

According to aspect B of the present invention there is provided a system for displaying actionable information on a vehicle according to the method of aspect A.

According to aspect C of the present invention there is provided a system for displaying actionable information on a vehicle, comprising: an electronic display panel; a processor in communication with the electronic display panel, the processor having computer-readable memory and a power supply; and a plurality of sensors in electrical communication with the processor, wherein the processor is configured to: receive data from the plurality of sensors; analyze the data received from each of the plurality of sensors to determine a data category for the data from each sensor, wherein each data category corresponds to an information priority level; control the electronic display panel to display the data from each of the plurality of sensors according to the determined data category, wherein data within a data category corresponding to a high information priority level is displayed more prominently relative to other data, and wherein data within a data category corresponding to a low information priority level is displayed less prominently relative to other data; and control the electronic display panel to display at least a portion of the data as at least one from the set of: a fuel cell voltage difference, a hydrogen flow rate, a temperature discrepancy, and a rate of temperature change.

Preferably the processor is further configured to: determine if the data received from each of the plurality of sensors is human-actionable; and for data that is human-actionable, display that data in a native state, and for data that is not human-actionable, process the non-human-actionable data to a human-actionable parameter and display the processed data.

Preferably the information priority level is one selected from the set of: data that is discarded, data to be reviewed, data displayed on demand, data displayed on low conspicuousness, data displayed in the primary display, highlighted data, signals to master caution, signals to master alarm, audio alerts, and control overrides.

Preferably the processor is further configured to display a user-selectable toggle wherein, depending on the data received from the plurality of sensors, operation of the vehicle is switchable between a normal operation and a limp home operation.

Preferably the display further includes at least one from the set of: an indicator of a failed sensor, an indicator of the selected operating mode, and a manual override against limp home operation.

Preferably the data category is at least partially determined by whether a value of the data from the aircraft sensor falls within a nominal, caution, or warning range.

Preferably the processor is further configured to: group data from a plurality of sensors together to create at least one data bin; determine a data category of the at least one data bin; and display an operating status of the at least one data bin.

Preferably the at least one data bin is at least one of: motor fuel cell, motor battery, inverter, fuel cell voltage, battery management system, pump, contactor, hydrogen management system, thrust, or power system controller.

Preferably at least one sensor data is displayed as a rate of change of the native data, wherein a parameter displayed as a rate of change of the data is at least one of: high temperature coolant loop inlet, high temperature coolant loop outlet, or cathode heat exchanger parameters.

Preferably the vehicle is an aircraft.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

In the drawings:

FIG. 1 is a flowchart illustrating a method for displaying actionable information on an electronic aircraft display panel;

FIG. 2 is a diagrammatical illustration of a system for displaying actionable information on an aircraft, in accordance with the present disclosure;

FIG. 3 is a diagrammatical illustration of a fuel cell aircraft display, in accordance with the present disclosure;

FIG. 4 is a diagrammatical illustration of fuel cell parameters binned together, in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

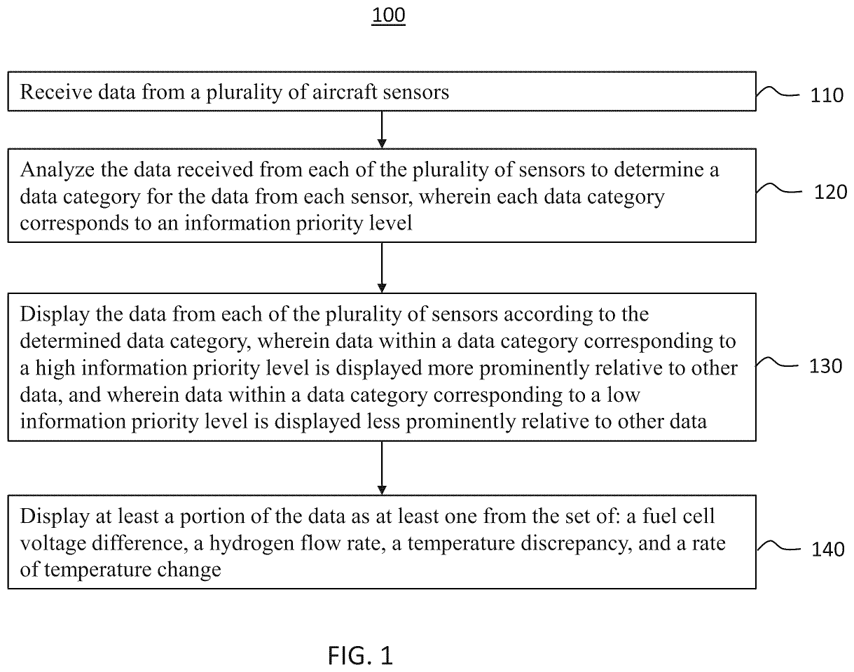

FIG. 1 is a flowchart 100 illustrating a method for displaying actionable information on an electronic aircraft display panel.

Step 110 includes receiving data from a plurality of aircraft sensors. The plurality of aircraft sensors may include any sensors located inside, outside, or in conjunction with an aircraft, including sensors corresponding to aircraft systems performance, positioning, operation, and the like. The aircraft sensors may be in data or electrical communication with a computer processor in order to receive the data from the plurality of aircraft sensors. In one example, this may include direct electrical connection, i.e., through wires. In another example, this may include connection over one or more data networks such as wired and wireless communications networks, i.e., cellular, radio, Wi-Fi®, Bluetooth®, NFC, satellite, LAN, WLAN, WAN, or any other similar networks. Data from the aircraft sensors may be communicated to the processor by any suitable means and using any suitable protocol for transmission and reception.

Step 120 includes analyzing the data received from each of the plurality of sensors to determine a data category for the data from each sensor, wherein each data category corresponds to an information priority level. The data may be placed into one or more of any number of data categories, depending on characteristics determined by analyzing the data. In one example, the data categories may be separated based on a determined priority level of the information communicated by the data from each sensor. Therefore, data corresponding to high priority information may be assigned a high priority data category, whereas data corresponding to low priority information may be assigned a lower priority data category. In one example, the data categories may be determined according to areas of critical concern for the flight crew. For instance, a lowest priority data category may include data that is generally unimportant and is immediately discarded. In one example, this may include nominal systems or operations data, data that is collected many times over an interval but cannot be processed by humans on the same frequency, and the like. The next level priority data category may include data that is stored, for instance, on computer-readable memory for later review and/or analysis. Such data may not be immediately important to note or review but may serve some purpose at a later time. The next level priority data category may include data that is displayed on demand. This may include data which is selected by the flight crew through prompts, user interface, scheduling, commands, and any other suitable methods. Such data may not be displayed unless explicitly requested by the flight crew and may not be displayed after some period of time. For instance, data related to particular operating systems, such as a particular engine, fuel source, or data related to ambient conditions, may be useful under particular circumstances and when called up by the flight crew.

The next level priority data category may include data that is displayed continuously in an inconspicuous manner, which does not attract the attention of the flight crew. This inconspicuous manner may include the size, shape, color, prominence, position on the display, typeface characteristics, brightness, motion and/or static nature, and any other characteristics which may make data display more or less prominently. In one example, data displayed less prominently may be smaller, may be colored using dull coloring, may be located outside of the center of the display or away from interest points such as where imaginary interest lines intersect in the “rule of thirds,” may have simplistic typeface, may be dim, or may be static compared with other data. Such data may include data which is not changing, data which is nominal, data for non-critical systems, and the like.

The next level priority data category may include data that is displayed continuously in a primary display. The primary display may include one or more separate displays intended for use as primary sources of information by the flight crew, as well as portions of a single display that may be reserved for primary display information, and any combination thereof. Such data may include nominal systems or operations data which must be continuously monitored, data pertaining to other aircraft, route and heading information, and the like.

The next level priority data category may include data that is highlighted in a visual, auditory, or tactile manner, or in some combination thereof. Highlighting may include any manner of distinguishing such data from other types of data, including varying or distinguishing the size, shape, color, prominence, position on the display, typeface characteristics, brightness, motion and/or static nature of the data. In particular, such data may be highlighted by varying or distinguishing the color or the brightness used to represent the data. For instance, data that begins to fall out of a nominal range may be represented in a warning color, such as orange or red, or may be highlighted by a brilliant color such as yellow to indicate that attention is needed. Visual highlighting may be combined with auditory highlighting, such as chirps, beeps, and other sounds, that may be made to correspond with visual signals. These may be combined further with tactile highlighting, which may include haptic feedback, buzzes, vibrations, and other sensory indicators that attention is needed.

The next level priority data category may include data that is sent to a master caution bus. The data sent to the master caution bus may include data determined to be within a caution range relative to a nominal range or value. The master caution bus may provide a general caution alert, a specific caution alert directed to the data, or a combination of both. The master caution bus may use any of the techniques discussed above to provide display alerts relative to the data.

The next level priority data category may include data that is sent to a master alarm. The data sent to the master alarm may include data determined to be within an alarm range relative to nominal range or value. This may include sensors for critical systems, data which is sufficiently outside of nominal or caution range, data which is changing at a rapid rate, or any combination thereof. The master alarm may provide a general alarm alert, a specific alarm alert directed to the data, or a combination of both. The master alarm may use any of the techniques discussed above to provide display alerts relative to the data.

The next level priority data category may include data that is sent to an audio alert. Audio alert data may include certain data which is best communicated as audio, for instance, audio signals, as well as audio cautions, warnings, and other audio data. In one example, audio alerts may not be direct communications of the aircraft data itself but may be an alert associated with a state of the data, for instance, a caution or alarm state. Audio alerts may be made by any suitable audio device, including speakers, audio drivers, and the like.

The next level priority data category may include data that is sent to a control overrides category. This may include data related to critical aircraft systems indicating operational performance may be compromised, data indicating that an aircraft has violated a rule or principle, or other data requiring one or more aircraft controls to be overridden. In one example, this may include flight controls, engine controls, communications controls, or interior environment controls, and the corresponding aircraft sensor data may include flight path, location, fuel cell temperature, inverter temperature, pump temperature, tank temperature, battery temperature, and the like. The effect of this data may be to cause a computerized override of the flight controls in order to preserve operation and/or safety of the aircraft.

Step 130 includes displaying the data from each of the plurality of sensors according to the determined data category, wherein data within a data category corresponding to a high information priority level is displayed more prominently relative to other data, and wherein data within a data category corresponding to a low information priority level is displayed less prominently relative to other data. In practice, this may mean that some data is not displayed at all, while some data is displayed periodically, on-demand, or at certain times, some data is displayed less prominently, and still other data is displayed constantly and very prominently, depending on the determined data category.

Step 140 includes displaying at least a portion of the data as at least one from the set of: a fuel cell voltage difference, a hydrogen flow rate, a temperature discrepancy, and a rate of temperature change. In other words, data may be received from a number of different sensors, and may be indicative of a number of various conditions within and around the aircraft. At least a portion of the data received may correspond to fuel cell voltage measurements, hydrogen flow, and temperature. And at least a portion of the data which is displayed may be displayed to indicate a fuel cell voltage difference, a hydrogen flow rate, a temperature discrepancy, a rate of temperature change, or any combination thereof. As used herein, a fuel cell voltage difference refers to a difference in the voltage measurement between two or more fuel cell batteries on an aircraft. A difference in voltage between these batteries may indicate the potential for a catastrophic problem if the batteries continue to be operated under normal conditions. Therefore, it may be useful to display a difference in the voltage or voltages, rather than, or in addition to, the individual voltage measurements. A hydrogen flow rate means the rate at which hydrogen flows from a tank into an anode. A rate which is too high or too low may indicate the potential for a catastrophic problem with the aircraft. A temperature discrepancy means an absolute temperature of a component in the power train, a rate at which the internal temperature of a fuel cell, temperature of a motor, or temperature of another component in the power train is increasing or decreasing. This may include rate changes of such parameters as the high temperature coolant loop inlet, high temperature coolant loop outlet, and cathode heat exchanger, among others. Temperature changes above a threshold rate, over an extended period, or after temperatures are already high or low may indicate the potential for a catastrophic problem with the aircraft. Therefore, it may be useful to display the rate of temperature change rather than, or in addition to, the real-time or average temperature measurements.

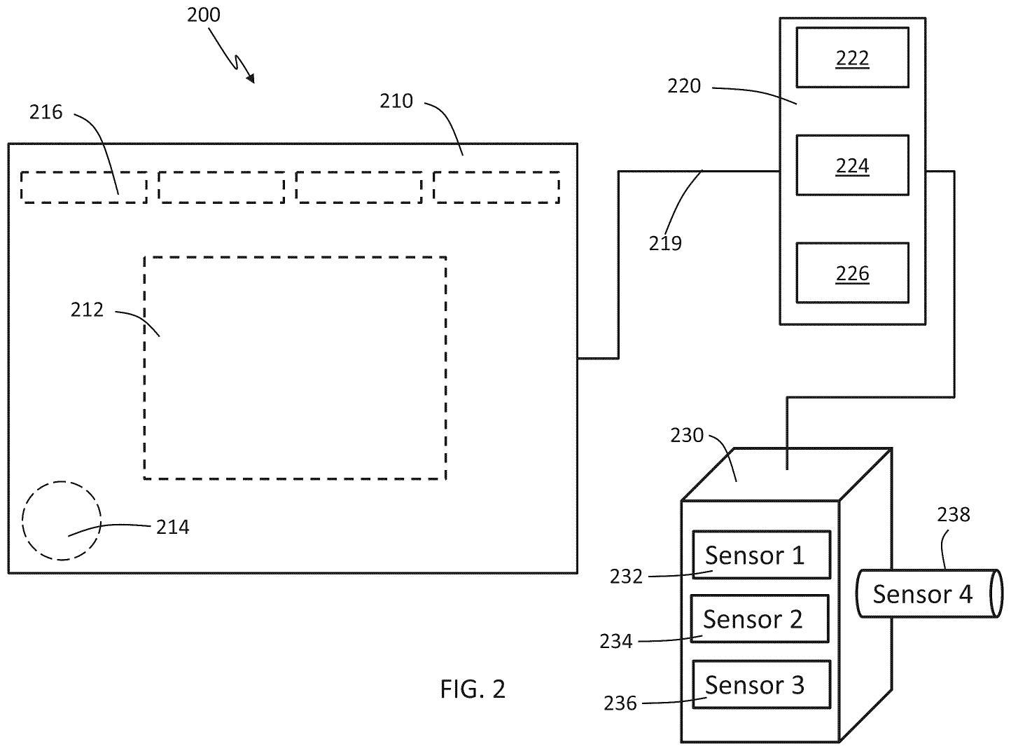

FIG. 2 is a diagrammatical illustration of a system for displaying actionable information on an aircraft (“system”) 200, in accordance with the present disclosure. The system 200 may include an electronic display panel 210. A processor 222 is in communication with the electronic display panel 210. The processor 222 has computer-readable memory 224 and a power supply 226. A plurality of aircraft sensors 232-238 (hereinafter collectively “sensors” 232-238) or sensor module 230 is in electrical communication with the processor 222. The processor 222 is configured to: receive data from the plurality of aircraft sensors 232-238; analyze the data received from each of the plurality of sensors 232-238 to determine a data category for the data from each sensor, wherein each data category corresponds to an information priority level; control the electronic display panel 210 to display the data from each of the plurality of sensors 232-238 according to the determined data category, wherein data within a data category corresponding to a high information priority level is displayed more prominently relative to other data, and wherein data within a data category corresponding to a low information priority level is displayed less prominently relative to other data; and control the electronic display panel 210 to display at least a portion of the data as at least one from the set of: a fuel cell voltage difference, a hydrogen flow rate, a temperature discrepancy, and a rate of temperature change.

The system 200 may be understood with reference to FIG. 1 above. The system 200 may include an electronic display panel 210. In one example, this may include one or more electronic display panels 210 located in one or more portions of the aircraft. For instance, the cockpit may include a plurality of electronic display panels 210 associated with the controls of the aircraft. The electronic display panel 210 may have any suitable size, shape, resolution, brightness, color space, contrast, or other physical characteristics typical of electronic display panels. In one example, the electronic display panels 210 may be permanent fixtures installed within the aircraft, i.e., as screens. In another example, the electronic display panels 210 may be portable mobile devices such as laptops, tablets, smartphones, smartwatches, smart displays, and the like. The electronic display panels 210 may be configured to correspond to data from particular aircraft sensors in one example. For instance, an electronic display panel 210 located near flight controls in the cockpit may be configured to display information corresponding to flight path, radar, and other related sensor information, while an electronic display panel 210 located near engine and battery controls may be configured to display information corresponding to the propulsion system sensors in the aircraft. In another example, the type of data displayed may be determined by the processor 222 or may be configurable by the aircraft crew. In operation, this may result in certain kinds of aircraft sensor data being processed according to the method described relative to FIG. 1 for each electronic display panel 210. In other words, where an aircraft has a single electronic display panel 210, all of the sensor data may be routed through the processor 222 and processed according to the method of FIG. 1. Where an aircraft has first and second electronic display panels 210, a first portion of the aircraft sensor data may be processed for display on the first electronic display panel 210, according to the method of FIG. 1, and a second portion of the aircraft sensor data may be processed for display on the second electronic display panel 210, according to the method of FIG. 1. In one example, the first and second portions of aircraft data may be different portions of data, i.e., from different aircraft sensors and relaying different information. In another example, the first and second portions of aircraft sensor data may include at least a portion of overlapping data, i.e., wherein some aircraft sensor data is common to both the first and second portions and is processed for display on both the first and second electronic display panels 210. In this way, certain sensor data may only be displayed or displayable on particular electronic display panels 210, while other sensor data may be displayed or displayable across multiple electronic display panels 210. For instance, data that correlates with the flight control of the aircraft may only be displayed on a single electronic display panel 210 in the cockpit, near the flight controls, since it would be irrelevant to anyone not operating the flight controls. Data that correlates with critical system information, such as the propulsion system status, may be displayed or displayable on multiple electronic displays 210 in the case of a critical emergency requiring attention from any crew member.

The electronic display panel 210 may be in communication with a processor 222. The communication may be over one or more networks 219, which may be wired or wireless, and which may be direct or indirect, as through a communications hub, server, proxy, or Internet connection. The processor 222 may include any suitable type, number, and implementation of processors for receiving, processing, and transmitting electronic sensor data. In operation, the processor 222 may be part of a computer system 220 in electrical communication with computer-readable memory 224 and a power supply 226. The computer system 220 may include any other computer hardware components typically used in such an environment, including networking components, specialized processing units, communications ports, receivers, transmitters, and the like. In one example, each electronic display panel 210 may operate using its own processor 222 or processors 222 to receive and process the aircraft sensor data and create the visual display. In another example, one or more central processors 222 may be responsible for all of the electronic processing tasks associated with the aircraft sensor data and the electronic display panel 210.

The plurality of aircraft sensors 232-238 in electrical communication with the processor 222 may include, in one example, four sensors 232, 234, 236, 238, as are shown in FIG. 2. However, it should be understood that any number, type, placement, size, function, and nature of sensors may be included within the scope of this disclosure. The aircraft sensors referred to within the scope of this disclosure may be any sensors, devices, or sources providing electronic information related to the operation of an aircraft, particularly when such information can be displayed on an electronic display panel 210. In the example illustrated in FIG. 2, the sensors shown are a pressure sensor 232, temperature sensor 234, voltage sensor 236, and motor RPM sensor 238. In one example, one or more of the sensors 232-238 may be part of the sensor module 230, such as a mass flow sensor module or other module located within the operational systems of the aircraft. For instance, a sensor module 230 may be located within the hydrogen management system, the power system, the battery management system, the fuel cells, the electrical systems, the motor, or elsewhere. Any sensor 232-238 or sensor module 230 may be in communication with the processor 222 to transmit sensor data to the processor 222.

The processor 222 is configured to receive data from the plurality of aircraft sensors 232-238. The sensors 232-238 may transmit data to the processor 222 in one or more different manners, at different rates, and according to different protocols, depending on the sensors and the data being detected and transmitted.

The processor 222 is configured to analyze the data received from each of the plurality of sensors 232-238 to determine a data category for the data from each sensor. The process of this analysis is described relative to FIG. 1, above, and may be performed electronically by the processor 222.

The processor 222 is further configured to control the electronic display panel 210 to display the data from each of the plurality of sensors 232-238 according to the determined data category, wherein data within a data category corresponding to a high information priority level is displayed more prominently relative to other data, and wherein data within a data category corresponding to a low information priority level is displayed less prominently relative to other data. In this manner, the processor 222 may communicate the data over the one or more networks 219, along with instructions for displaying the data on the electronic display panel 210. Some exemplary display embodiments are illustrated in FIG. 2.

In one example, data determined to correspond to high-priority information may be displayed in a conspicuous portion of the electronic display panel 210. For instance, data that is to be displayed continuously in the primary display may be displayed in the center of the display 212 where it is easily seen. In another example, this conspicuous display area 212 may depend on other factors, such as the amount and characteristics of other data being displayed on the electronic display panel 210, the physical placement and location of the electronic display panel 210 relative to the viewer, and the like. For instance, a conspicuous display area 212 may be located at the top of the display area in some cases, or a corner of the display area, or any other suitable location. In one example, the conspicuous display area 212 may be a large portion of the electronic display panel 210, for instance, more than 25% of the total display area.

In another example, data determined to correspond to lower-priority information may be displayed in a less conspicuous portion of the electronic display panel 210. For instance, data that is to not to be displayed continuously may be displayed in a small portion of a corner of the display 214, or along a side, or in another small, inconspicuous area. This may include data which is callable by the aircraft crew by manipulation of a user interface such as aircraft controls, a keyboard, buttons, joystick, touchscreen interface, voice command, and the like. For instance, data from a plurality of aircraft sensors may be categorized in this manner, and may be accessible within this display area. Once a user selects the area using the controls, the data may be displayed by way of toggle, expansion, rotation, or other method.

In another example, data determined to correspond to lower-priority information to be displayed continuously, but with low conspicuousness, may be permanently displayed along a top row 216 of the electronic display panel 210, or along a bottom row like a news chyron. This may allow the aircraft crew to review such information when necessary. In this example, several types of data may be displayed adjacent to one another.

In the example of data that is immediately discarded, such data may not be displayed on any portion of the electronic display panel 210. Likewise, for data that is logged for later review or analysis, such data may not be displayed at the time it is received and processed by the processor 222. When the processor 222 or aircraft crew determines such data should be reviewed, it may be displayed on the electronic display panel 210 at that time. In one example, at the time of later review or analysis, the processor 222 may be configured to make a new determination of a data category pertaining to the later-reviewed data. At that time, such later data may proceed through the method steps described relative to FIG. 1 and performed by the processor 222, and thereby may be displayed according to the determination of the data category at that time.

In the example of data that is highlighted, such data may be displayed in any suitable location on the electronic display panel 210. Such data may be accompanied by, highlighted with, surrounded by, or otherwise indicated with one or more colors on the electronic display panel 210 operating to contrast the data from other data being displayed. Highlighting may be performed over a period of time, i.e., when data falls within a particular range of values or when a data value has crossed a particular threshold, i.e., when fuel has been depleted below a certain level, or based on other conditions as appropriate.

In the example of data that is sent to the master caution bus, such data may be displayed in a manner or location that indicates its caution status. For instance, a portion of the electronic display panel 210 may be dedicated to caution bus data, and data that was previously displayed elsewhere (or not displayed at all) may be displayed in the caution space when such data is determined to have a master caution data category. In another example, caution data may be displayed with particular colors or contrasts, such as flashing orange lighting.

In the example of data that is sent to the master alarm bus, such data may be displayed in a manner or location that indicates its alarm status. For instance, a portion of the electronic display panel 210 may be dedicated to alarm bus data, and data that was previously displayed elsewhere (or not displayed at all) may be displayed in the alarm space when such data is determined to have a master alarm data category. In another example, alarm data may be displayed with particular colors or contrasts, such as flashing red lighting.

In the example of data that triggers an audio alert, such audio alerts may be visually indicated using colors, bolding, symbols, brightness, or other contrasting or differentiating visual displays to indicate that an audio alert is being triggered. In one example, a visual icon such as a speaker may indicate that an audio alert is triggering due to a particular set of data.

In the example of data that triggers a control override, the display may include the data itself and notice or indication of the control override being initiated. For instance, if data from a particular sensor has crossed above a critical threshold value, the electronic display panel 210 may display the data—and in one example, a caution or alarm—and a display element that indicates that the control override is being initiated in the system related to the sensor. For instance, if a fuel cell temperature were to cross above a critical threshold value, the electronic display panel 210 may display the data value in one of the display areas 212, 214, 216 along with text or graphics indicating that the particular fuel cell associated with the sensor is being overridden to improve the issue. In another example, if the remaining fuel crosses below a threshold value, the electronic display panel 210 may display the data value of the remaining fuel in one of the display areas 212, 214, 216 along with text or graphics indicating that the aircraft controls are being overridden and the aircraft is making an emergency landing.

In another example, the processor 222 may be configured to display information corresponding to an operating mode of the aircraft. For instance, the aircraft may operate in a manual control mode, an automatic pilot mode, a control override mode, a “limp home” mode, or a manual override mode. Depending on the operating mode and the display associated with the operating mode, the electronic display panel 210 may show a number of display elements, pieces of data, and other information. In one example, the electronic display panel 210 may display information corresponding to a process for switching between a normal operating mode and a “limp home” mode, useful for when the aircraft has low power reserves or is damaged in some way. In another example, the electronic display panel 210 may display information corresponding to a failed aircraft sensor. In another example, the electronic display panel 210 may display information corresponding to an operating mode that has been selected. In another example, the electronic display panel 210 may display information corresponding to a process for overriding “limp home” mode in order to provide additional power to the aircraft.

In one example, the computer system 220 may include a powertrain system controller in communication with the aircraft sensors 232-238. The flight controller system may receive and log the data from the aircraft sensors 232-238, while a separate processing unit generates display statuses from control logic.

The processor 222 may be further configured to control the electronic display panel 210 to display at least a portion of the data as at least one from the set of: a fuel cell voltage difference, a hydrogen flow rate, a temperature discrepancy, and a rate of temperature change. In one particular example, the processor 222 may perform the following logic sequence to determine the display for data from a fuel cell voltage sensor: first, data may be reported by the fuel cell voltage sensor across all voltages; the stack voltage, minimum cell voltage, average cell voltage, and maximum cell voltage may be computed; the average cell voltage and the minimum cell voltage may be compared against one another; and the average cell voltage and the maximum cell voltage may be compared against one another. If the minimum cell voltage is less than or equal to a trigger threshold, a trigger indicator may be displayed. If the minimum cell voltage is greater than the trigger threshold, then a nominal status may be displayed; if the average cell voltage modified by the maximum cell voltage is greater than or equal to a different trigger threshold, then another trigger indicator may be displayed; otherwise, nominal operating status may be displayed. In one particular example, the caution trigger condition may be made when the maximum cell voltage is greater than or equal to a caution threshold of 1.1V; when the minimum cell voltage is less than or equal to a caution threshold of 0.4V; when the stack voltage is greater than or equal to a caution threshold of 500V; when the arithmetic difference of the average cell voltage to the maximum cell voltage is greater than or equal to a caution threshold of 0.08V for more than 0.5 seconds; and when the arithmetic difference of the average cell voltage to the minimum cell voltage is greater than or equal to a caution threshold of 0.08V for more than 0.5 seconds.

A warning may be triggered when the maximum cell voltage is greater than or equal to a warning threshold of 1.2V; when the minimum cell voltage is less than or equal to a warning threshold of 0.55V; when the stack voltage is greater than or equal to a warning threshold of 520V; when the arithmetic difference of the average cell voltage to the maximum cell voltage is greater than or equal to a warning threshold of 0.1V for more than 0.5 seconds; and when the arithmetic difference of the average cell voltage to the minimum cell voltage is greater than or equal to a warning threshold of 0.1V for more than 0.5 seconds.

The processor 222 may perform the following logic sequence to determine the display for data from a hydrogen flow rate sensor. Hydrogen flow rate may be estimated from mass, temperature and pressure measurements or directly measured. Data may be reported as a maximum, minimum, average, or rate of change. In one particular example, the estimated hydrogen mass is displayed as a quantity that is updated at every 16 milliseconds to show rate of change.

The processor 222 may perform the following logic sequence to determine the display for data from a temperature sensor. Output from the temperature sensor may be analog and may need an analog-to-digital converter. Signal processing or conditioning techniques may be applied on the sensor output, including offsets, linearization, noise filtering and temporal averaging. Output may need to be converted to the correct scientific units. Temperature data may be reported as maximum temperature, minimum temperature, average temperature, and rate of change. Average and minimum temperatures may be compared against one another, and average and maximum temperatures may be compared against one another. If maximum temperature exceeds a trigger threshold, a trigger indicator may be displayed. In one particular example, monitored temperature may include inverter coolant loops, motor coolant loops, and hydrogen tank temperatures. When temperature is displayed as a rate of change, such as the coolant loop inlet, temperature may be updated at the display refresh rate every 16 milliseconds.

This may be looped or performed periodically or recursively in order to update the fuel cell aircraft condition to the aircraft crew. Some hysteresis may be built into the system to allow the aircraft crew time to react. In one example, after a visual indicator alerts a crew member to an off-nominal condition and the issue is resolved, the indicator may un-trigger. The crew member may also have a control override option.

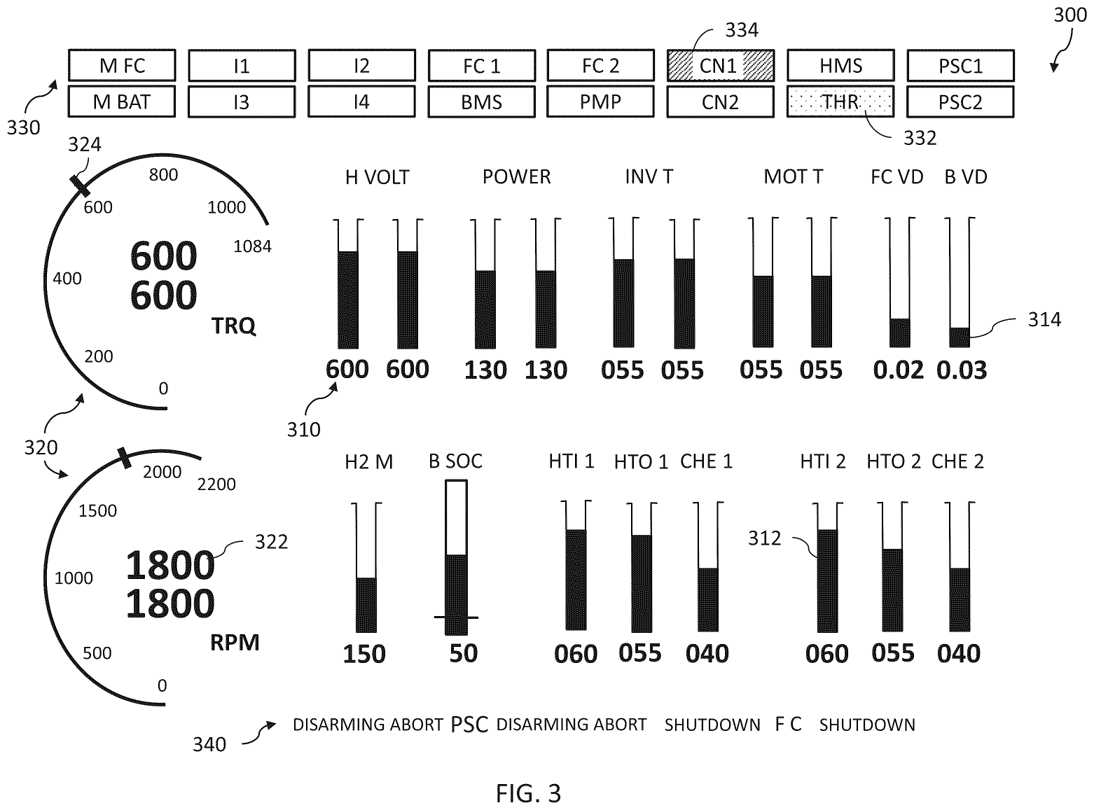

FIG. 3 is a diagrammatical illustration of a fuel cell aircraft display 300, in accordance with the present disclosure. The fuel cell aircraft display 300 (hereinafter “display” 300) may include a number of graphical and textual elements to communicate data from the aircraft sensors 232-238. It should be understood that the display elements shown in FIG. 3 are exemplary and are not intended to limit the scope of the disclosure. Other elements or combinations of elements may be considered within the scope of the disclosure where suitable.

In one example, the display 300 may include one or more linear gauge charts 310 indicating the value of sensor data as it lies between two relative or absolute points. The linear gauge charts 310 may resemble tanks which are in varying stages of fullness depending on the value of the sensor data relative to the two points at the lower end and upper end of the gauge range. In one example, the linear gauge charts 310 may include both graphical elements and numerical elements to provide an indication of the absolute value of the sensor data, the gauge range, or both. For instance, the example in FIG. 3 illustrates a first linear gauge chart for a hydrogen voltage sensor, reading at an absolute value of 600 units and appearing to substantially fill the gauge graphic. Additional linear gauge charts 310 shown may include charts for power, inverter temperature, motor temperature, fuel cell voltage difference, battery voltage difference, hydrogen mass, battery state of charge, and the high temperature coolant loop inlet, high temperature coolant loop outlet, and cathode heat exchanger. These parameters may be displayed numerically to show a precise quantity, or graphically to show relative changes or rate of change. The linear gauge graphic for the battery voltage difference, for example, shown by reference character 314, is illustrated showing the value to be low relative to the upper value of the range for that sensor. In contrast, the high temperature coolant loop inlet parameter, indicated by reference character 312, is shown to be high relative to the upper value of the range for that sensor. This visual display, combined with the absolute numerical expression of the underlying data, may enable the aircraft crew to quickly understand and interpret the meaning of the data presented by the plurality of aircraft sensors shown.

In another example, the display 300 may include one or more circular gauge charts 320 including graphical and/or numerical display elements. The circular gauge charts 320 may provide moving indicators of the value of sensor data relative to certain points within a value range. In one example, a graphical indicator 324 may travel around the circular gauge to indicate the relative value of the aircraft sensor data. In another example, numerical indicators 322 may provide the precise value of the sensor data. The circular gauge charts 320 may further include numerical markers spaced periodically to indicate value points within a data range, for instance at 0, 500, 1,000, 1,500, 2,000, and 2,200 units. In the example shown in FIG. 3, a first circular gauge chart 320 is shown indicating a torque of the motor at 600 units. A second circular gauge chart 320 is shown indicating the rotational speed of the motor at 1800 rotations per minute. It should be understood that any suitable aircraft sensor or sensed parameters may be expressed and displayed in this manner.

In another example, the display 300 may include a plurality of subsystem icons 330 indicating the operating status of one or more subsystems, superset categories, or aircraft sensors. FIG. 3 shows, by way of example, the following subsystem icons 330: motor fuel cell, motor battery, inverter 1, inverter 2, inverter 3, inverter 4, fuel cell voltage 1, fuel cell voltage 2, battery management system, pump, contactor 1, contactor 2, hydrogen management system, thrust, power system controller 1, and power system controller 2. It should be understood that other sensors, subsystems, or categories of data may be displayed or otherwise expressed in this manner. FIG. 3 shows the subsystem icons 330 as rectangular graphical elements; however, any suitable shape, size, number, and type of elements may be used.

The subsystem icons 330 may provide a rough or relative indication of the operating status of each subsystem to which it corresponds. In one example, this may include an indication of nominal operating status, an indication of caution operating status, an indication of alarm operating status, an indication of failure, an indication of rapid change in sensor data value, and the like. For instance, subsystems which are operating at nominal status may be displayed as neutral icons with inconspicuous colors or without color. In one example, the subsystems operating at nominal status may be displayed with green fill. Subsystems which are operating at caution status, such as the thrust subsystem 332, may be displayed with a caution color or visual indicator, for instance, an orange fill. In the example shown in FIG. 3, the thrust subsystem 332 is illustrated with a dotted fill for ease of illustration. Subsystems which are operating at an alert status, such as the CN1 (contactor 1) subsystem 334, may be displayed with an alert color or visual indicator, for instance, a red fill. In the example shown in FIG. 3, the CN1 subsystem 334 is illustrated with a crossed fill for ease of illustration. It should be understood that any color, pattern, or other visual fill elements may be used to indicate the caution or warning status of the subsystems. Subsystems which are operating at a failure status may be displayed with a failure color or visual indicator, such as a black fill or bright red cross-hatching. Subsystems which are operating at a rapid change in sensor data value may be displayed with an indicator of the change. For instance, sensor data which is increasing may be indicated by the display of one or more up arrows, a partial green fill in an upper portion of the icon 330, or some other indicator. Sensor data which is decreasing may be indicated by the display of one or more down arrows, a partial orange fill in a lower portion of the icon 330, or some other indicator.

In one example, the parameters displayed on the display 300 may be temporally-based. In other words, only parameters which can be addressed by an aircraft crew member may be displayed. This may also be referred to as “human-actionable data”. In one example, this may be parameters which update or present over a time of about 100 milliseconds or more. Parameters which are updated or presented at a faster time may be processed in order to make them more actionable within a human timescale. For instance, parameters such as fuel cell voltages and coolant temperatures may be averaged or binned over about a 100-millisecond time before being displayed on the display 300. Certain other parameters with short update times may be presented in other ways, such as using bars to show the rate of change. In operation, the processor 222 may determine if the data received from each aircraft sensor is human-actionable. Data that is human-actionable may be displayed in a native state, i.e., at the rate it is received. Data that is not human-actionable may be processed to a human-actionable parameter by averaging or binning before being displayed.

In another example, the display 300 may include textual display elements 340 indicating controls or operating options for systems on the aircraft. In the example shown in FIG. 3, textual display elements 340 for the power system controller and the fuel cell are shown, including options to disarm, abort, and shut down the systems. The textual display elements 340 may indicate whether and which choices have been selected by the aircraft crew.

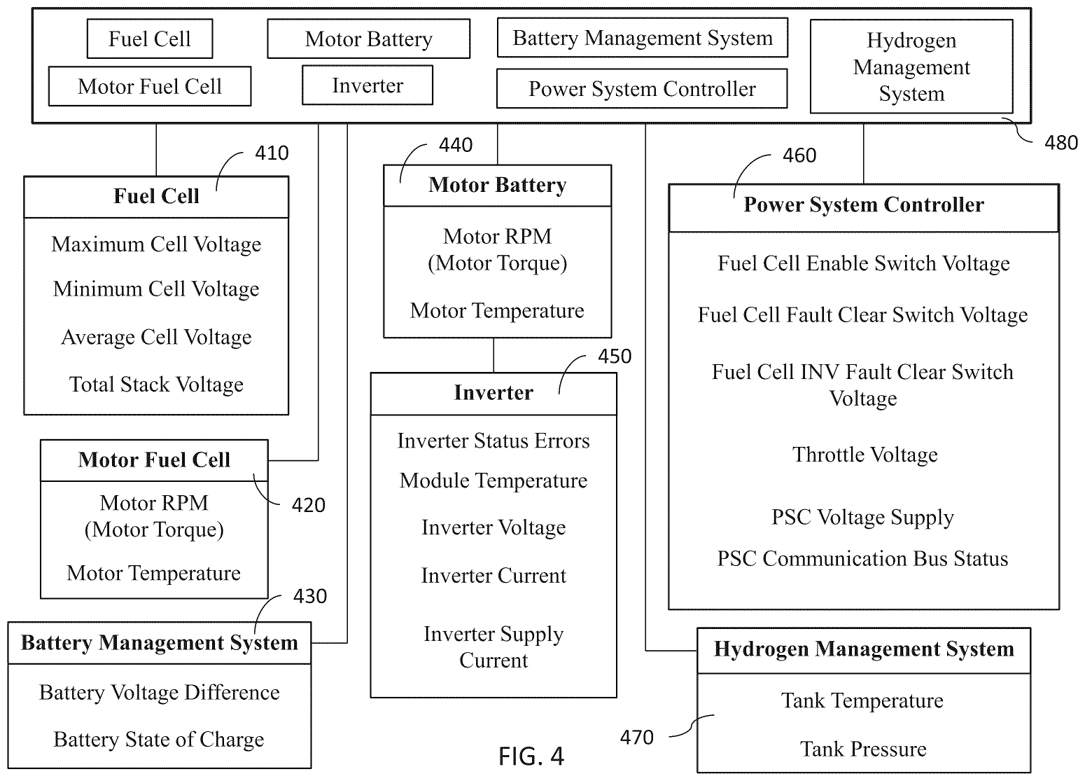

FIG. 4 is a diagrammatical illustration of fuel cell parameters binned together, in accordance with the present disclosure. As described relative to FIG. 3 above, certain categories of aircraft sensors may be considered together such that their operating status is collectively indicated rather than individually indicated on the display 300. This may reduce clutter by limiting the number of display elements visible on the display. The binned groups may be determined by any suitable manner. In one example, sensors conveying data about related subsystems may be binned together so as to more accurately convey the operating status of each subsystem. FIG. 4 illustrates an example of one binning scheme relevant to fuel cell powered aircraft:

Bin 410 is a bin directed to the sensors within the fuel cell subsystem. Parameters detected by these sensors may include, but are not limited to, maximum fuel cell voltage, minimum fuel cell voltage, average fuel cell voltage, and total stack voltage. Bin 420 is a bin directed to the sensors within the motor fuel cell. Parameters detected by these sensors may include, but are not limited to, the motor RPM (motor torque) and motor temperature. Bin 430 is a bin directed to the sensors within the battery management system. Parameters detected by these sensors may include, but are not limited to, a battery voltage difference and a battery state of charge, i.e., whether and to what extent the battery is charging.

Bin 440 is a bin directed to the sensors within the motor battery subsystem. Parameters detected by these sensors may include, but are not limited to, the motor battery RPM (motor torque) and motor temperature. Bin 450 is a bin directed to the inverter subsystem, an electrical power component subsystem. Parameters detected by these sensors may include, but are not limited to, inverter status errors, module temperature, inverter voltage, inverter current, and inverter supply current.

Bin 460 is a bin directed to the power system controller subsystem. Parameters detected by these sensors may include, but are not limited to, fuel cell enable switch voltage, fuel cell fault clear switch voltage, fuel cell inverter fault clear switch voltage, throttle voltage, power system controller voltage supply, and power system controller communication bus status. Bin 470 is a bin directed to the hydrogen management system. Parameters detected by these sensors may include, but are not limited to, tank temperature and tank pressure.

All of the bins 410-470 may be displayed on the display 300 using one or more of the manners described above, for instance using subsystem icons 330 as is shown in block 480. In one example, fuel cell temperatures may be displayed as a rate of change so that the aircraft crew can assess the relative increase and/or decrease of the temperatures during the operation of the aircraft. In particular, the temperature parameters that may be reported as a rate of change are the high temperature coolant loop inlet, high temperature coolant loop outlet, and cathode heat exchanger. Display as a rate of change may be more useful for encouraging aircraft crew action than merely displaying a status of a parameter within the subsystem.

In one example, fuel cell voltage nominality may be determined and displayed on the display 300. The following parameters are calculated to characterize the fuel cell system health: maximum cell voltage, minimum cell voltage, average cell voltage calculated as the arithmetic mean in a trailing 500 millisecond window, and the overall fuel cell stack voltage.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

What is claimed:

1. A method for displaying actionable information on a vehicle display panel, comprising the following steps:
receiving data from a plurality of aircraft sensors;
analyzing the data received from each of the plurality of sensors to determine a data category for the data from each sensor, wherein each data category corresponds to an information priority level;
displaying the data from each of the plurality of sensors according to the determined data category, wherein data within a data category corresponding to a high information priority level is displayed more prominently relative to other data, and wherein data within a data category corresponding to a low information priority level is displayed less prominently relative to other data; and
displaying at least a portion of the data as at least one from the set of: a fuel cell voltage difference, a hydrogen flow rate, a temperature discrepancy, and a rate of temperature change.

2. The method of claim 1, wherein the information priority level is one selected from the set of: data that is discarded, data to be reviewed, data displayed on demand, data displayed on low conspicuousness, data displayed in the primary display, highlighted data, signals to master caution, signals to master alarm, audio alerts, and control overrides.

3. The method of claim 1, further comprising the steps of:
(A) determining if the data received from each of the plurality of sensors is human-actionable; and
for data that is human-actionable, displaying that data in a native state, and for data that is not human-actionable, processing the non-human-actionable data to a human-actionable parameter and displaying the processed data; and/or
(B) further comprising the step of displaying a user-selectable toggle wherein, depending on the data received from the plurality of aircraft sensors, operation of the vehicle is switchable between a normal operation and a limp home operation.

4. The method of claim 1, wherein the vehicle is an aircraft, and wherein the display further includes at least one from the set of: an indicator of a failed aircraft sensor, an indicator of the selected operating mode, and a manual override against limp home operation, and/or
wherein the data category is at least partially determined by whether a value of the data from the aircraft sensor falls within a nominal, caution, or warning range.

5. The method of claim 1, wherein the vehicle is an aircraft, and further comprising the steps of:
grouping data from a plurality of aircraft sensors together to create at least one data bin;
determining a data category of the at least one data bin; and
displaying an operating status of the at least one data bin, and optionally wherein the at least one data bin is at least one of: motor fuel cell, motor battery, inverter, fuel cell voltage, battery management system, pump, contactor, hydrogen management system, thrust, or power system controller.

6. The method of claim 1, wherein the vehicle is an aircraft, and wherein at least one aircraft sensor data is displayed as a rate of change of the data, and optionally wherein a parameter displayed as a rate of change of the data is at least one of: high temperature coolant loop inlet, high temperature coolant loop outlet, or cathode heat exchanger parameters.

7. A system for displaying actionable information on a vehicle, comprising:
an electronic display panel;
a processor in communication with the electronic display panel, the processor having computer-readable memory and a power supply; and
a plurality of sensors in electrical communication with the processor, wherein the processor is configured to:
receive data from the plurality of sensors;
analyze the data received from each of the plurality of sensors to determine a data category for the data from each sensor, wherein each data category corresponds to an information priority level;
control the electronic display panel to display the data from each of the plurality of sensors according to the determined data category, wherein data within a data category corresponding to a high information priority level is displayed more prominently relative to other data, and wherein data within a data category corresponding to a low information priority level is displayed less prominently relative to other data; and
control the electronic display panel to display at least a portion of the data as at least one from the set of: a fuel cell voltage difference, a hydrogen flow rate, a temperature discrepancy, and a rate of temperature change.

8. The system of claim 7, wherein the processor is further configured to:
determine if the data received from each of the plurality of sensors is human-actionable; and
for data that is human-actionable, display that data in a native state, and for data that is not human-actionable, process the non-human-actionable data to a human-actionable parameter and display the processed data.

9. The system of claim 7, wherein the information priority level is one selected from the set of: data that is discarded, data to be reviewed, data displayed on demand, data displayed on low conspicuousness, data displayed in the primary display, highlighted data, signals to master caution, signals to master alarm, audio alerts, and control overrides.

10. The system of claim 7, wherein the processor is further configured to display a user-selectable toggle wherein, depending on the data received from the plurality of sensors, operation of the vehicle is switchable between a normal operation and a limp home operation.

11. The system of claim 7, wherein the display further includes at least one from the set of: an indicator of a failed sensor, an indicator of the selected operating mode, and a manual override against limp home operation.

12. The system of claim 7, wherein the data category is at least partially determined by whether a value of the data from the aircraft sensor falls within a nominal, caution, or warning range.

13. The system of claim 7, wherein the processor is further configured to:
group data from a plurality of sensors together to create at least one data bin;
determine a data category of the at least one data bin; and
display an operating status of the at least one data bin, and optionally wherein the at least one data bin is at least one of: motor fuel cell, motor battery, inverter, fuel cell voltage, battery management system, pump, contactor, hydrogen management system, thrust, or power system controller.

14. The system of claim 7, wherein at least one sensor data is displayed as a rate of change of the native data, wherein a parameter displayed as a rate of change of the data is at least one of: high temperature coolant loop inlet, high temperature coolant loop outlet, or cathode heat exchanger parameters.

15. The system of claim 7, wherein the vehicle is an aircraft.
